(19) United States
(12) Patent Application Publication
(10) Pub. No.: US 2023/0063369 A1
(43) Pub. Date: Mar. 2, 2023

(54) MAGNETIC PEAK LOAD AVERSION IN A WAVE ENERGY CONVERSION SYSTEM

(71) Applicant: Narayan R Iyer, Iowa City, IA (US)

(72) Inventor: Narayan R Iyer, Iowa City, IA (US)

(21) Appl. No.: 18/046,929

(22) Filed: Oct. 16, 2022

Related U.S. Application Data
(63) Continuation-in-part of application No. 17/388,559, filed on Jul. 29, 2021.
(60) Provisional application No. 63/366,625, filed on Jun. 17, 2022.
(60) Provisional application No. 63/365,486, filed on May 28, 2022.
(60) Provisional application No. 63/269,106, filed on Mar. 9, 2022.
(60) Provisional application No. 63/262,636, filed on Oct. 17, 2021.
(60) Provisional application No. 63/136,284, filed on Jan. 12, 2021.

(51) Int. Cl. F03B 13/16; H02K 49/10; H02K 11/02; H02K 7/116; H02K 7/18

(52) U.S. Cl. CPC F03B 13/16; H02K 49/108; H02K 11/02; H02K 7/116; H02K 7/1853

(57) ABSTRACT

The method and apparatus disclosed herein conveys a wave energy converter (WEC) that comprises a strategically placed magnetic coupler that selectively transfers motion to a power takeoff (PTO) system so as to not damage components within the buoy during severe wave conditions, while still always allowing motion to be transferred to/from a restorative mechanism of the WEC so that the excitation and restorative motions of the wave energy converter are uninhibited by said selective transfer of motion to the PTO.

### CROSS REFERENCE TO RELATED APPLICATIONS

This application is a non-provisional patent application which claims the benefit of US provisional patent applications having Serial Numbers: U.S. 63/262,636, which was filed on Oct. 17th, 2021, U.S. 63/269,106, which was filed on Mar. 9th 2022, U.S. 63/365,486, which was filed on May 28th 2022, and U.S. 63/366,625, which was filed on Jun. 17th 2022, all of which are incorporated herein in their entirety by this reference.

This application is a continuation-in part of U.S. patent application Ser. No. 17/388,559, filed Jul. 29, 2021. This application is incorporated herein in its entirety by this reference.

### FIELD OF THE INVENTION

In an Ocean environment, irregular and severe wave conditions may occur that can damage a wave energy system. However, over-engineering a wave energy system will render it less optimal for nominal sea-states. There exists a need for a wave energy converter to avoid transferring high forces into more delicate components such as gearboxes and generators, and avoid over-engineering of the system as a whole. There also exists a need to allow for aversion of said severe conditions without affecting the proper oscillating excitation and restorative motion of the wave energy converter. Therefore, the present invention introduces a means to avert high forces, induced by an ocean wave, in a passive manner using non-physical magnetic coupling, whilst not affecting a restorative mechanism in said aversion.

### BACKGROUND OF THE INVENTION

In the past, many wave energy converters (WECs) have been proposed as a means to generate electricity or desalinate seawater. Some such proposals have included means of dissipating high forces sustained by the WECs, such a device is described in U.S. Pat. No. 10,352,291 B2 by Oscilla Power, wherein a hydraulic method of peak load dissipation is discussed. However, this method requires active controls via manipulation of moving parts such as valves and/or pistons. Such moving parts can corrode or biofoul in sea conditions, and such active controls are complex to design and build.

The present invention solves the problem by using a passive magnetic coupling that uncouples when the source force is too high. The present invention also describes the location with respect to other WEC components wherein said magnetic coupling needs to be placed, as well as the use of magnetic patterns such as the Halbach array to increase the magnetic force of the magnetic coupling.

Wave energy systems generally comprise of:
a body that absorbs wave motion,
a connection, such as rope, that links said absorbing body to a more stiff reaction body such as a seafloor or other less wave-responsive underwater or above-water body,
a restorative mechanism such as a spring that brings the buoy back to an equilibrium position once the wave subsides, and
a power takeoff system that carries out desalination or electricity production.

The present invention strategically places a magnetic coupler between these components so as to not adversely affect the motion of the buoy whilst keeping the more delicate PTO safe from damage.

### SUMMARY OF THE INVENTION

Peak load averting magnetic coupling of a wave energy converter needs to be located strategically. Most wave energy converters have a restoration method: a method that restores the WEC to an equilibrium position, such as a spring. In the present invention's exemplary embodiment, a rotatory body such as a reel or sheave, is physically coupled to a restorative mechanism such as a spring. The sheave is also physically coupled to a first magnetic unit of a magnetic coupler; the sheave is not however physically coupled to the power-takeoff (gearboxes if any and generator) of the wave energy converter, instead a second magnetic unit of the magnetic coupler is physically coupled to the power takeoff, and the second magnetic unit is non-physically and magnetically coupled to the first magnetic unit.

It is an object of the present invention to provide a system to passively decouple motion transfer in a wave energy converter when the wave force surpasses a threshold, which causes an exceedance at the magnetic coupling beyond a net magnetic coupling strength.

It is an advantage of the present invention to avoid peak loads in a passive manner instead of using complex active controls with moving parts.

It is a feature of the present invention to provide a Halbach array to increase magnetic coupling force.

It is an advantage of the present invention to provide adequate magnetic coupling force using less magnetic material, saving costs and weight.

It is a feature of the present invention to physically couple a restorative mechanism, such as a spring or a counter-weight, to a rotatory body (sheave, reel or gear) that physically receives motion due to a wave energy absorber body motion relative to a reaction body, whilst not physically coupling said rotatory body to a power take-off.

It is an advantage of the present invention to allow the restorative mechanism (spring or counter-weight) to get energized by the wave to then subsequently restore the buoy to an equilibrium position once the wave subsides, even during high wave forces, whilst not energizing the PTO mechanism during said high wave forces.

It is a feature of the present invention to provide magnetic shielding material, such as MuMetal, to mitigate magnetic interference among magnetic and/or induced magnetic components.

It is a feature of the present invention to provide passive magnetic decoupling at moments when external forces on a wave energy system surpass stress limits of any components of said system.

The present invention is an apparatus and system for magnetically transferring motion in a selective manner which is designed to satisfy the aforementioned needs, provide the previously stated objects, include the above-listed features, and achieve the already articulated advantages. The present invention is carried out in accordance with the claims, in a sense that magnetic forces are involved in stated transfer of force and motion.

Accordingly, the present invention is a method to inhibit transmission of an input load exceeding a threshold, to a power-takeoff system in a wave energy converter, the method comprising the steps of:

transferring a relative motion, between an absorber body and a reaction body, to a rotatory body;

wherein the reaction body is at least one of solid earth and a body that is less responsive to a water wave motion than the absorber body;

providing a magnetic coupler comprising a first magnetic unit and a second magnetic unit, with each magnetic unit comprising at least one magnet,

wherein the first magnetic unit and second magnetic unit, combined, comprise a maximum net magnetic strength, wherein a net load exerted on the coupler that is above said maximum strength causes the first magnetic unit to move substantially independently from the second magnetic unit;

wherein the first magnetic unit substantially transfers motion, via magnetic force, to the second magnetic unit, only if the net load exerted on the coupler is at or below said strength;

transferring the input load from the rotatory body to the first magnetic unit through a physical medium, wherein the input load is caused by at least one of
a wave induced load; and
a restorative load produced by the restorative mechanism;

transferring motion from the rotatory body to a power takeoff, via the coupler, when the input load does not exceed the threshold, and at the same moment, transferring motion between the rotatory body and a restorative mechanism;

allowing an increasing input load, when said input load does not exceed the threshold, to increase the power takeoff's power conversion, thus causing an increase in a power takeoff resistive load, which in turn contributes to the increase in a net resistive load at the second magnetic unit, with said increase in power takeoff's power conversion continuing until said the net resistive load at the second magnetic unit equals the net magnetic strength of the coupler;

wherein the power takeoff resistive load is at least partially formed as a result of energy conversion of the power takeoff; and

allowing the net resistive load at the second magnetic unit to surpass the net magnetic strength when said input load exceeds the threshold, thus causing the first magnetic unit to move independently of the second magnetic unit, while at the same moment, transferring motion between the rotatory body and a restorative mechanism.

Additionally, the present invention is a method to convert water body wave motion to usable energy, the method comprising the steps of:

providing an absorber body that is allowed to move relative to a reaction body;

wherein said motion of the absorber body is in response to a water wave motion;

wherein the reaction body is at least one of solid earth and a body less responsive to said water wave motion than the absorber body;

physically transferring the relative motion of the absorber body, with respect to the reaction body, to a rotatory body;

wherein the rotatory body is physically coupled with a first magnetic unit;

wherein the rotatory body is, at least in part, substantially non-physically coupled with a second magnetic unit by a net magnetic force, while said rotatory body being physically coupled with a restorative mechanism;

wherein the restorative mechanism provides restorative force to bring the absorber body toward an equilibrium after a wave force, which displaced the absorber body away from said equilibrium, substantially subsides;

wherein the second magnetic unit is physically coupled to a power takeoff system;

wherein the first magnetic unit comprises at least one magnet;

wherein the second magnetic unit comprises at least one magnet; and

wherein the power takeoff converts at least a portion of a motion of the second magnetic unit to usable energy.

Additionally, the present invention is an apparatus that converts water body wave motion to usable energy, the apparatus comprising:

an absorber body that is allowed to move relative to a reaction body (20);

wherein said motion of the absorber body is in response to a water body's wave motion;

wherein the reaction body is at least one of solid earth and a body less responsive to said water body wave motion than the absorber body;

a means to transfer the relative motion of the absorber body, with respect to the reaction body, to a rotatory body;

wherein the rotatory body is physically coupled with a first magnetic unit (6);

wherein the rotatory body is, at least in part, substantially non-physically coupled with a second magnetic unit by a net magnetic force and physically coupled with a restorative mechanism;

wherein the restorative mechanism provides restorative force to bring the absorber body toward an equilibrium after a wave force, which displaced the absorber body away from said equilibrium, substantially subsides;

wherein the second magnetic unit is physically coupled to a power takeoff system;

wherein the first magnetic unit comprises at least one magnet;

wherein the second magnetic unit comprises at least one magnet; and

wherein the power takeoff converts at least a portion of a motion of the second magnetic unit to usable energy.

### BRIEF DESCRIPTION OF THE DRAWINGS

The invention may be more fully understood by reading the description of the preferred embodiments of the invention, in conjunction with the appended drawings wherein:

FIG. 1 shows a front-top-left perspective view of one embodiment of the present invention, wherein the wave energy buoy body 2 is made opaque to show internal components of said body.

FIG. 2 shows the same embodiment as FIG. 1 from a front view without the buoy body and water shown.

FIG. 3 shows an alternative embodiment of FIGS. 1 and 2 without the buoy body and water shown.

FIG. 4a and 4b show the embodiment of FIG. 2. wherein a load is building up as the wave energy converter encounters more of a wave.

FIG. 5 shows the same embodiment of FIG. 4a and 4b, wherein the load has built up beyond a threshold value.

FIG. 6 shows an alternate embodiment of the current invention, wherein a barrier is provided to waterproof compartments within a wave energy converter.

FIG. 7 shows a perspective view of one embodiment of a magnetic unit of a magnetic coupler, with magnets hidden.

FIG. 8 shows the same embodiment of FIG. 7 but with magnets visible.

FIG. 9 shows one embodiment of FIG. 7, wherein a removable plate prevents the magnets from being pulled out of the pockets.

### DETAILED DESCRIPTION

The details below should be viewed as examples of many potential variations of the present invention which are protected hereunder.

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalents; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any one or any combinations of one or more of the associated listed items. As used in this paper, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As stated herein, a load is at least one of a force and a torque.

The present invention is a method and related apparatus for magnetically providing a non-physical motion link that can uncouple without causing physical wear, or other damage whilst allowing the wave energy converter to retain restorative dynamic properties via an uninterrupted connection to a restorative mechanism. An advantage of the present invention is to minimize maintenance requirements of wave energy converters (WECs) that can occur due to wear and stress, as well as provide storm damage protection.

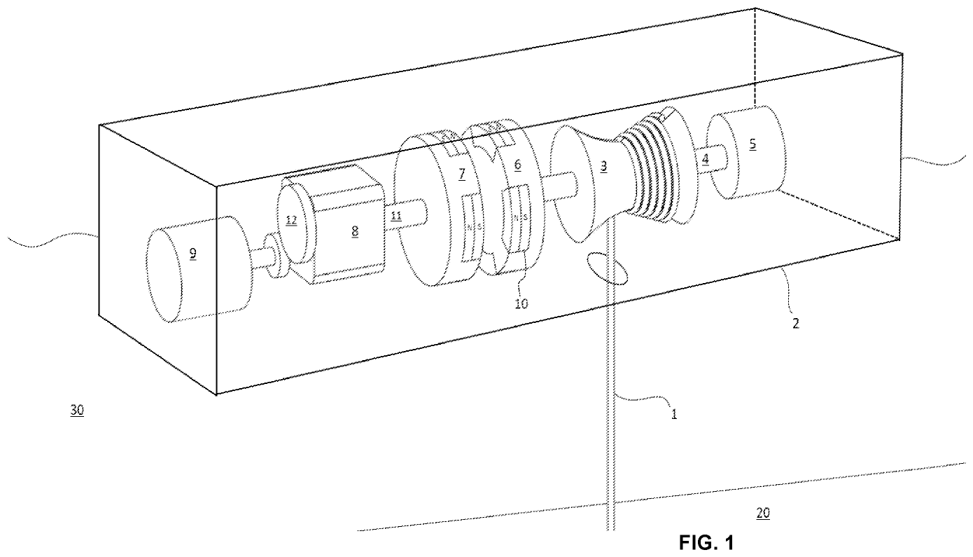

Referring to FIG. 1, a wave energy converter is shown at least partially submerged in a water body 30, with said wave energy converter having an absorber buoy body 2, connected via a flexible link 1 to the seafloor 20, here the seafloor is the reaction body. A reaction body is one which the absorber body moves relative to in order for wave energy conversion to occur. FIG. 1 depicts the flexible link 1 being wound around a rotatory body 3, such as a sheave. In some embodiments, the sheave 3 is physically connected with a rotational spring 5 via a shaft 4.

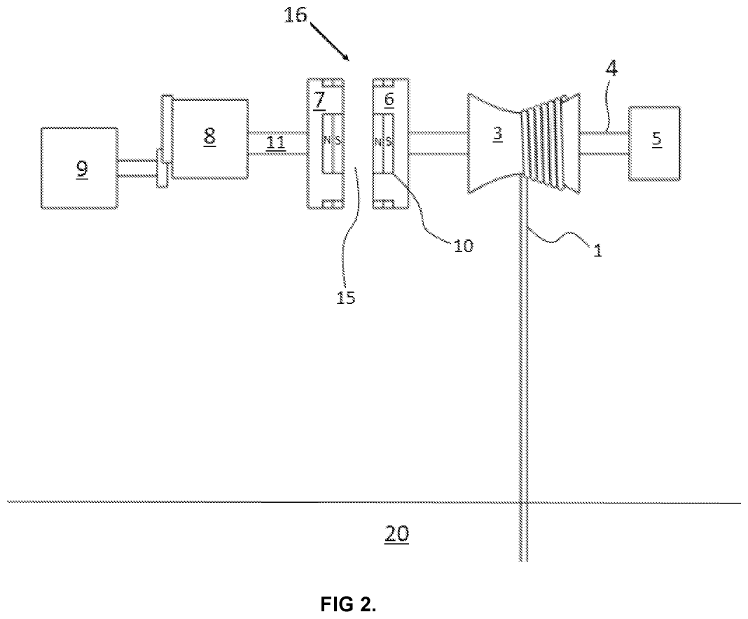

Now referring to FIG. 2, the same embodiment is shown with the water body and buoy body hidden. The first magnetic unit 6 is physically coupled with the sheave 3, and is also physically coupled with a restorative mechanism 5, which in the embodiment of FIG. 2 is a rotational spring. The first magnetic unit 6 comprises at least one magnet 10, and is configured in the substantial magnetic influence of the second magnetic unit 7 with a non-physical gap 15. There is no physical coupling between the first magnetic unit and the second magnetic unit in any manner that substantially transfers motion. The second magnetic unit 7 is physically coupled to the power takeoff in which motion is transferable from the second magnetic unit to the power takeoff. In some embodiments, the power takeoff comprises at least one of a generator 9 and a gearbox 8. In some embodiments, the power takeoff is any of a desalinator and a hydraulic turbine. As stated herein, coupling refers to a connection between two or more components that transfers motion between said components.

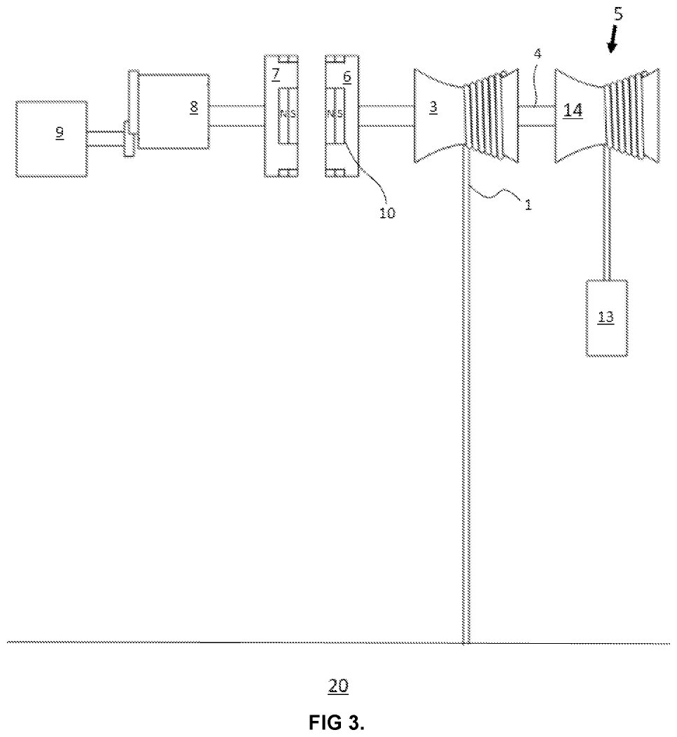

Now referring to FIG. 3, instead of a rotational spring as the restorative mechanism 5, the restorative mechanism 5 comprises a hanging weight 13 coupled to a second sheave 14. Now referring back to FIG. 2 in view of FIG. 3, it can be understood that any mechanism that stores some type of potential energy when wave induced forces occur, and then releases said potential energy after wave induced forces subside, can be used as the restorative mechanism. In some embodiments, the restorative mechanism is at least one of a hydraulic and a pneumatic spring.

The first magnetic unit 6 and the second magnetic unit 7 of the magnetic coupler 16 comprise a maximum net magnetic attractive strength, which is the maximum torque within which the first magnetic unit and second magnetic unit are coupled to each other via magnetic attractive forces. Once said net magnetic attractive strength is exceeded by some external load (source external to coupler), the first and second magnetic units decouple and move relative to each other. In some embodiments, strength is defined by the level at which the component has the ability to accommodate a load without decoupling.

In order to turn a generator to produce electricity, a resistive torque has to be overcome. In other words, work needs to be done against a resistive torque produced by the generator as it turns, to produce electricity. In some embodiments, this is known as generator back torque, and this load is in addition to friction in the generator and any inertial effects. A power takeoff converting energy, including desalinators, will produce a back load (force and/or torque) that opposes the load that is causing the energy conversion. This back load is a resistive load of the power takeoff.

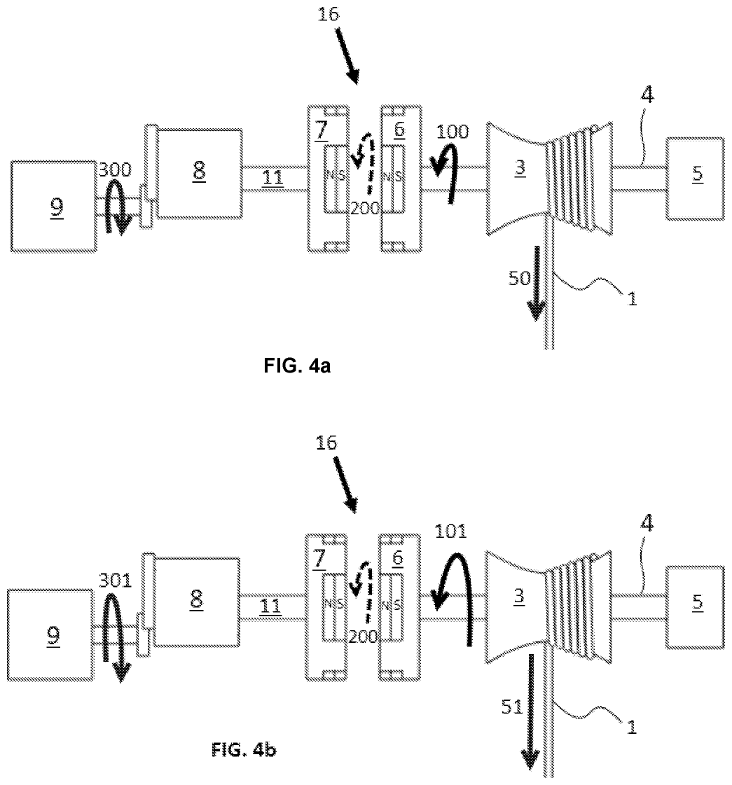

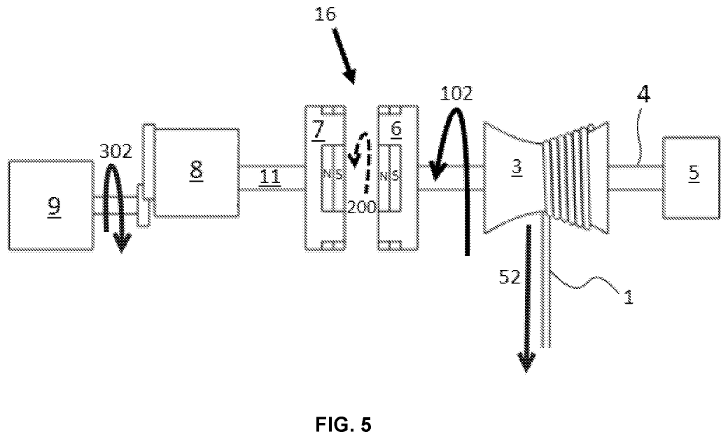

Now referring to FIG. 4a and 4b, wave induced force is shown to build 50 and 51, wherein the 51 force is greater than the 50 force, and the wave induced forces lead to a wave induced torque 100 and 101. In some embodiments, the wave induced load 100 builds up 101, as seen from FIG. 4a to 4b, as the buoy faces more of a particular wave. 4a and 4b show the buildup of wave induced load within a threshold, wherein said threshold corresponds to the net magnetic attractive strength 200 of the magnetic coupler. In other words, the threshold corresponds to the point at which the coupler decouples. The non threshold-exceeding wave induced load is transmitted to the power takeoff, via the magnetic coupler 16 in a coupled state. In some embodiments, as the wave induced load 100 (4a) increases, within the threshold, to load 101 (4b), the power takeoff increases in power output (work done per second), and the power takeoff resistive load increases, from 300 to 301 (FIG. 4a to 4b). However, referring to FIG. 4b and FIG. 5, if the wave induced load 101 further increases to said threshold 102, the power takeoff resistive load 301 increases to a point 302 wherein the resulting resistive load faced at the second magnetic unit 7 surpasses the maximum net magnetic strength 200 needed to sustain coupling between the first 6 and second 7 magnetic units, therefore the coupler will substantially decouple and the first magnetic unit 6 and the second magnetic unit 7 start to move with a relative motion, i.e. independently, thereby no longer transmitting the wave induced load 102 (or greater than 102) to the power takeoff. However, during this decoupled state of the magnetic coupler 16, motion transfer between the rotatory body and the restorative mechanism is not decoupled.

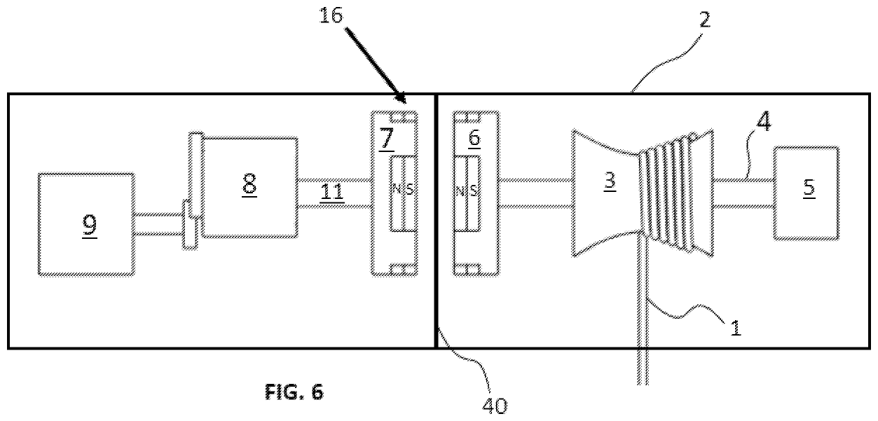

Referring to FIG. 6, another embodiment of the present invention is shown wherein a physical barrier is provided in between the two magnetic units of the magnetic coupler. In some embodiments, said physical barrier allows for water proofing between different compartments of a wave energy body, and the magnetic couplers allow for a seamless transfer of motion between said compartments.

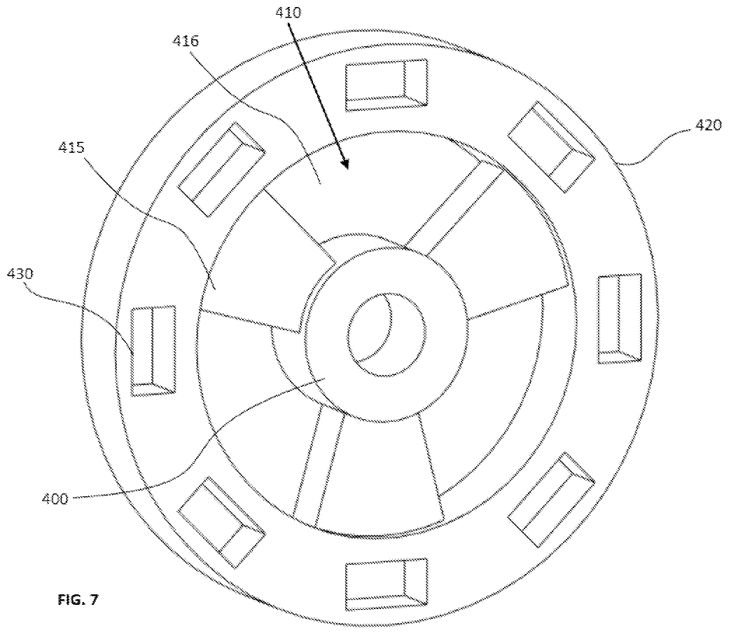

Now referring to FIG. 7, an embodiment of a magnetic unit is shown. The magnetic unit 67 is one embodiment of any of the magnetic units 6 and 7, shown in previous drawings. Permanent magnets can be expensive in large sizes especially for larger wave energy converters, therefore in order to reduce the mass and number of magnets needed to undertake magnetic transfer of motion within the coupling threshold, the embodiment shown in FIG. 7 comprises pockets 430 for magnet placement, wherein said magnets can be placed near the periphery of the magnetic unit, allowing for a high torque to manifest in a low force that is able to be accommodated by the magnetic attractive forces of the peripheral magnets. If instead the magnets were placed closer to the center of the disk-like magnetic unit, a high torque would manifest as a high force for each magnet, which the magnetic attractive forces between 2 magnetic units may not be able to accommodate, causing the need for more magnets to prevent premature decoupling. The magnetic unit 67 comprises an inner ring 400, an interim region 410 and an outer ring 420. The interim region 420 is between the inner ring 400 and outer ring 420. In some embodiments, the interim region 410 comprises at least one of:

material gaps 416; and

reduced thickness connection members 415 that connect the inner ring 400 to the outer ring 420.

In other words, in some embodiments, there may not be a material gap 416 but the interim region comprises material that is of lower thickness than the inner and outer ring. This practice allows the use of less material to construct the magnetic unit. Material gaps also allow for less material usage.

In some embodiments, referring back to FIG. 1, subsequent magnets 10 within a given magnetic unit are arranged in an opposite configuration between each other.

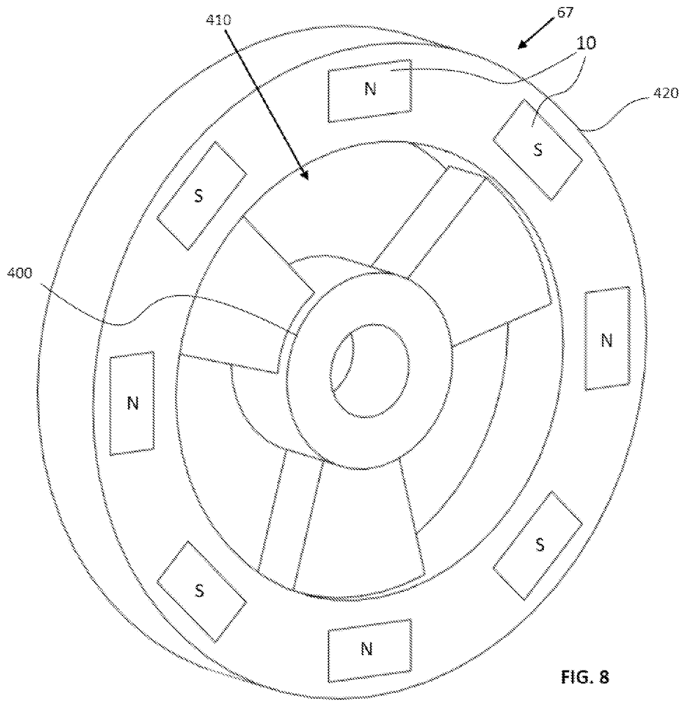

Now referring to FIG. 8, the embodiment of FIG. 7 is shown with magnets 10 now also shown, and said magnets 10 placed within said pockets 430. Although only one pole is visible per magnet, the other pole is on the opposite side of the shown magnet 10.

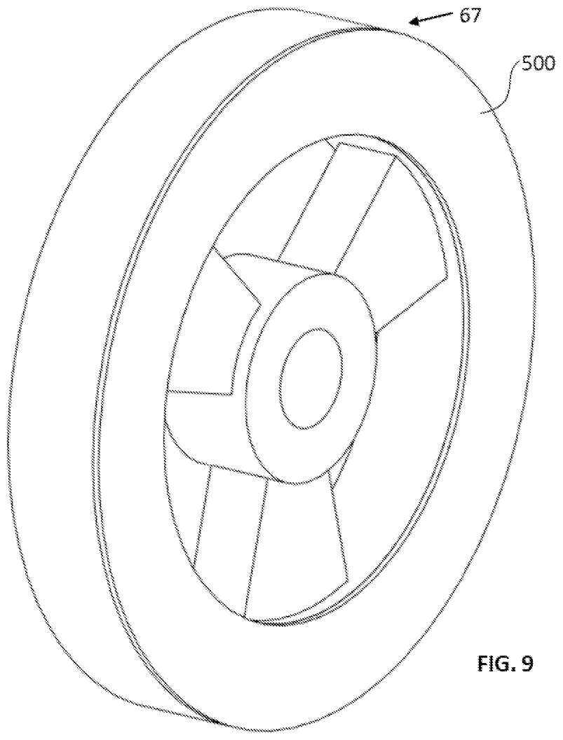

Now referring to FIG. 9, a plate 500 is shown, which in some embodiments is removable from the rest of the magnetic unit 67, with said plate ensuring that the magnets 10 will not fall out, especially due to attractive forces between adjacent magnetic units.

In some embodiments, the magnet 10 is an electromagnet.

In some embodiments, a mechanical coupler can be included in the wave energy system, wherein the coupler comprises a threshold after which the coupler passively decouples. In some embodiments, the mechanical coupler comprises a type of ratcheting gear that further comprises collapsible or retractable teeth that are kept erect by corresponding springs. When a force threshold is surpassed, the springs can no longer keep the teeth erect, causing the teeth to collapse and prevent motion transfer between the coupler. In some embodiments, the mechanical coupler stated herein replaces the magnetic coupler stated herein.

Back to the magnetic coupling invention, a physical connection or a physical couplement, between two or more components, is one that has a physical motion transfer medium between said components, without any exclusively non-physical motion transfer interruption in said path.

In some embodiments, the reaction body is the seafloor 20. In some embodiments, the reaction body is a body that is less responsive to water body wave motion compared to the absorber body, and is not the seafloor.

I claim:

1. A method to inhibit transmission of an input load (102) exceeding a threshold, to a power-takeoff system in a wave energy converter, the method comprising the steps of:
transferring a relative motion, between an absorber body (2) and a reaction body (20), to a rotatory body (3);
wherein the reaction body (20) is at least one solid earth and a body that is less responsive to a water wave motion than the absorber body (2);
providing a magnetic coupler (16) comprising a first magnetic unit (6) and a second magnetic unit (7), with each magnetic unit comprising at least one magnet (10),
wherein the first magnetic unit (6) and second magnetic unit (7), combined, comprise a maximum net magnetic strength (200), wherein a net load exerted on the coupler that is above said maximum strength causes the first magnetic unit (6) to move substantially independently from the second magnetic unit (7);
wherein the first magnetic unit (6) substantially transfers motion, via magnetic force, to the second magnetic unit (7), only if the net load exerted on the coupler is at or below said strength;
transferring the input load (100)(101)(102) from the rotatory body (3) to the first magnetic unit (6) through a physical medium, wherein the input load (100)(101)(102) is caused by at least one of
a wave induced load (50); and
a restorative load produced by the restorative mechanism (5);
transferring motion from the rotatory body (3) to a power takeoff (8)(9), via the coupler (16), when the input load (100)(101) does not exceed the threshold, and at the same moment in time, transferring motion between the rotatory body (3) and a restorative mechanism (5);
allowing an increasing input load (100)(101), when said input load does not exceed the threshold, to increase the power takeoff's power conversion, thus causing an increase in a power takeoff resistive load (300)(301), which in turn contributes to the increase in a net resistive load at the second magnetic unit (7), with said increase in power takeoff's power conversion continuing until said net resistive load at the second magnetic unit (7) equals the maximum net magnetic strength (200) of the coupler;
wherein the power takeoff resistive load (301) is at least partially formed as a result of energy conversion of the power takeoff; and
allowing the net resistive load at the second magnetic unit (7) to surpass the maximum net magnetic strength (200) when said input load (102) exceeds the threshold, thus causing the first magnetic unit (6) to move independently of the second magnetic unit (7), while at the same moment, transferring motion between the rotatory body (3) and a restorative mechanism (5).

2. The method according to claim 1, wherein the at least one magnet in the first magnetic unit (6) is a plurality of magnets arranged in a Halbach array.

3. The method according to claim 1, wherein the at least one magnet in the second magnetic unit (7) is a plurality of magnets arranged in a Halbach array.

4. The method according to claim 1, wherein said magnetic coupling between the first magnetic unit (6) and second magnetic unit (7), is effective only at a range, of at least one of force and torque, at which each of the components affected by said at least one of torque and force, undergo stress below at least one of
a fatigue endurance limit;
a fatigue strength defined at an operational life of the wave energy converter; and
a fatigue strength defined at the operational life of the component.

5. A method to convert water body wave motion to usable energy, the method comprising the steps of:
providing an absorber body (2) that is allowed to move relative to a reaction body (20);
wherein said motion of the absorber body (2) is in response to a water (30) wave motion;
wherein the reaction body is at least one of solid earth (20) and a body less responsive to said water wave motion than the absorber body (2);
physically transferring the relative motion of the absorber body (2), with respect to the reaction body (20), to a rotatory body (3);
wherein the rotatory body (3) is physically coupled with a first magnetic unit (6);
wherein the rotatory body (3) is, at least in part, substantially non-physically coupled with a second magnetic unit (7) by a net magnetic force, while said rotatory body (3) being physically coupled with a restorative mechanism (5);
wherein the restorative mechanism (5) provides restorative force to bring the absorber body (2) toward an equilibrium after a wave force, which displaced the absorber body (2) away from said equilibrium, substantially subsides;
wherein the second magnetic unit (7) is physically coupled to a power takeoff system (8)(9);
wherein the first magnetic unit (6) comprises at least one magnet (10);
wherein the second magnetic unit (7) comprises at least one magnet (10); and
wherein the power takeoff (8)(9) converts at least a portion of a motion of the second magnetic unit to usable energy.

6. The method according to claim 5, wherein the at least one magnet in the first magnetic unit (6) is a plurality of magnets arranged in a Halbach array.

7. The method according to claim 5, wherein the at least one magnet in the second magnetic unit (7) is a plurality of magnets arranged in a Halbach array.

8. The method according to claim 5, wherein said magnetic coupling between the first magnetic unit and second magnetic unit, is effective only at a range, of at least one of force and torque, at which each of the components affected by said at least one of torque and force, undergo stress below at least one of
a fatigue endurance limit;
a fatigue strength defined at an operational life of the wave energy converter; and
a fatigue strength defined at the operational life of the component.

9. The method according to claim 5, further comprising the step of providing magnetic shielding material to limit the coverage of magnetic field lines.

10. The method according to claim 5, further comprising the step of providing a physical barrier between the first magnetic unit and the second magnetic unit.

11. The method according to claim 10, wherein the physical barrier prevents the transfer of at least one of freshwater and seawater between compartments in a wave energy converter.

12. The method according to claim 5, wherein at least one of the first magnetic unit (6) and second magnetic unit (7), comprise
an inner ring (400);
an outer ring (420) that further comprises at least one magnet (10); and
an interim region (410) that further comprises at least one of
at least one material gap (416); and
at least one connection member (415) that connects the inner ring (400) to the outer ring (420), wherein said connection member comprises less of a characteristic thickness than the inner ring (400) and the outer ring (420).

13. An apparatus that converts water body wave motion to usable energy, the apparatus comprising:
an absorber body (2) that is allowed to move relative to a reaction body (20);
wherein said motion of the absorber body (2) is in response to a water body's (30) wave motion;
wherein the reaction body is at least one of solid earth (20) and a body less responsive to said water body wave motion than the absorber body (2);
a means to transfer the relative motion of the absorber body (2), with respect to the reaction body (20), to a rotatory body (3);
wherein the rotatory body (3) is physically coupled with a first magnetic unit (6);
wherein the rotatory body (3) is, at least in part, substantially non-physically coupled with a second magnetic unit (7) by a net magnetic force and physically coupled with a restorative mechanism (5);
wherein the restorative mechanism (5) provides restorative force to bring the absorber body (2) toward an equilibrium after a wave force, which displaced the absorber body (2) away from said equilibrium, substantially subsides;
wherein the second magnetic unit (7) is physically coupled to a power takeoff system (8)(9);
wherein the first magnetic unit (6) comprises at least one magnet (10);
wherein the second magnetic unit (7) comprises at least one magnet (10); and
wherein the power takeoff (8)(9) converts at least a portion of a motion of the second magnetic unit to usable energy.

14. The apparatus according to claim 13, wherein the at least one magnet in the first magnetic unit (6) is a plurality of magnets arranged in a Halbach array.

15. The apparatus according to claim 13, wherein the at least one magnet in the second magnetic unit (7) is a plurality of magnets arranged in a Halbach array.

16. The apparatus according to claim 13, wherein said magnetic coupling between the first magnetic unit and second magnetic unit, is effective only at a range, of at least one of force and torque, at which each of the components affected by said at least one of torque and force, undergo stress below at least one of
a fatigue endurance limit;
a fatigue strength defined at an operational life of the wave energy converter; and
a fatigue strength defined at the operational life of the component.

17. The apparatus according to claim 13, further comprising magnetic shielding material to limit the coverage of magnetic field lines.

18. The apparatus according to claim 13, further comprising a physical barrier between the first magnetic unit and the second magnetic unit.

19. The apparatus according to claim 13, wherein the physical barrier prevents the transfer of at least one of freshwater and seawater between compartments in a wave energy converter.

20. The apparatus according to claim 13, wherein at least one of the first magnetic unit (6) and second magnetic unit (7), comprise
an inner ring (400);
an outer ring (420) that further comprises at least one magnet (10); and
an interim region (410) that further comprises at least one of
at least one material gap (416); and
at least one connection member (415) that connects the inner ring (400) to the outer ring (420), wherein said connection member comprises less of a characteristic thickness than the inner ring (400) and the outer ring (420).
